(19) United States
(12) Patent Application Publication
(10) Pub. No.: US 2015/0046302 A1
(43) Pub. Date: Feb. 12, 2015

(54) TRANSACTION LEVEL MODELING METHOD AND APPARATUS

(71) Applicant: Mastercard International Incorporated, Purchase, NY (US)

(72) Inventors: Po HU, Norwalk, CT (US); Jean-Pierre GERARD, Croton-On- Hudson, NY (US); Tong ZHANG, Greenwich, CT (US)

(73) Assignee: Mastercard International Incorporated, Purchase, NY (US)

(21) Appl. No.: 13/963,284

(22) Filed: Aug. 9, 2013

(51) Int. Cl. G06Q 40/00; G06Q 10/06

(52) U.S. Cl. CPC G06Q 40/12; G06Q 10/067
USPC 705/30

(57) ABSTRACT

A system, method, and computer-readable storage medium configured to enable transaction level modeling of payment card use.

### BACKGROUND

1. Field of the Disclosure

Aspects of the disclosure relate in general to data mining financial services. Aspects include an apparatus, system, method and computer-readable storage medium to enable transaction level modeling of payment card purchases.

2. Description of the Related Art

The use of payment cards, such as credit or debit cards, is ubiquitous in commerce. Typically, a payment card is electronically linked via a payment network to an account or accounts belonging to a cardholder. These accounts are generally deposit accounts, loan or credit accounts at an issuer financial institution. During a purchase transaction, the cardholder can present the payment card in lieu of cash or other forms of payment.

Payment networks process trillions of purchase transactions by cardholders. The data from the purchase transactions can be used to analyze cardholder behavior. Typically, the transaction level data can be used only after it is summarized up to customer level. Unfortunately, the current transaction rolled-up processes are pre-knowledge based and does not result in transaction level models. For example, a merchant category code (MCC) or industry sector are to classify purchase transactions and summarize transactions in each category. This kind of summarization of information is a generic approach without using target information.

### SUMMARY

Embodiments include a system, apparatus, device, method and computer-readable medium configured to enable transaction level modeling of payment card use.

In a payment network method embodiment, the payment network receives transaction data regarding a financial transaction, the transaction data including a transaction attribute. A processor generates a customer level target specific variable layer from the transaction data. The processor models cardholder behavior with the customer level target specific variable layer to create a model of cardholder behavior. The model of cardholder behavior is saved to a non-transitory computer-readable storage medium.

A payment network embodiment includes a processor and a network interface. The processor is configured to receive transaction data regarding a financial transaction, the transaction data including a transaction attribute. The processor is also configured to generate a customer level target specific variable layer from the transaction data, and to model cardholder behavior with the customer level target specific variable layer to create a model of cardholder behavior. The model of cardholder behavior is saved to a non-transitory computer-readable storage medium.

A non-transitory computer readable medium embodiment is encoded with data and instructions. When the data and instructions are executed by a computing device, the instructions causing the computing device to receive transaction data regarding a financial transaction, the transaction data including a transaction attribute, to generate, a customer level target specific variable layer from the transaction data, to model cardholder behavior with the customer level target specific variable layer to create a model of cardholder behavior. The model of cardholder behavior is saved to a non-transitory computer-readable storage medium.

### BRIEF DESCRIPTION OF THE DRAWINGS

FIG. 1 illustrates an embodiment of a system configured to enable transaction level modeling of payment card use.

FIG. 2 depicts a data flow diagram of a payment network configured to enable transaction level modeling of payment card use.

### DETAILED DESCRIPTION

One aspect of the disclosure includes the realization that enabling transaction level modeling of payment card use improves fraud-prevention on the payment card.

Another aspect of the disclosure includes the understanding that analyzing cardholder spending can create opportunities to increase cardholder satisfaction through offering convenience and ancillary services to the cardholder. Ancillary services may include elite cardholder services, and vendor offers.

Yet another aspect of the disclosure is the realization that a transaction level model may be applied to any multiple-layer optimization problem including issuer payment data and merchant purchase data.

Embodiments of the present disclosure include a system, method, and computer-readable storage medium configured to enable transaction level modeling of payment card use. For the purposes of this disclosure, a payment card includes, but is not limited to: credit cards, debit cards, prepaid cards, electronic checking, electronic wallet, or mobile device payments.

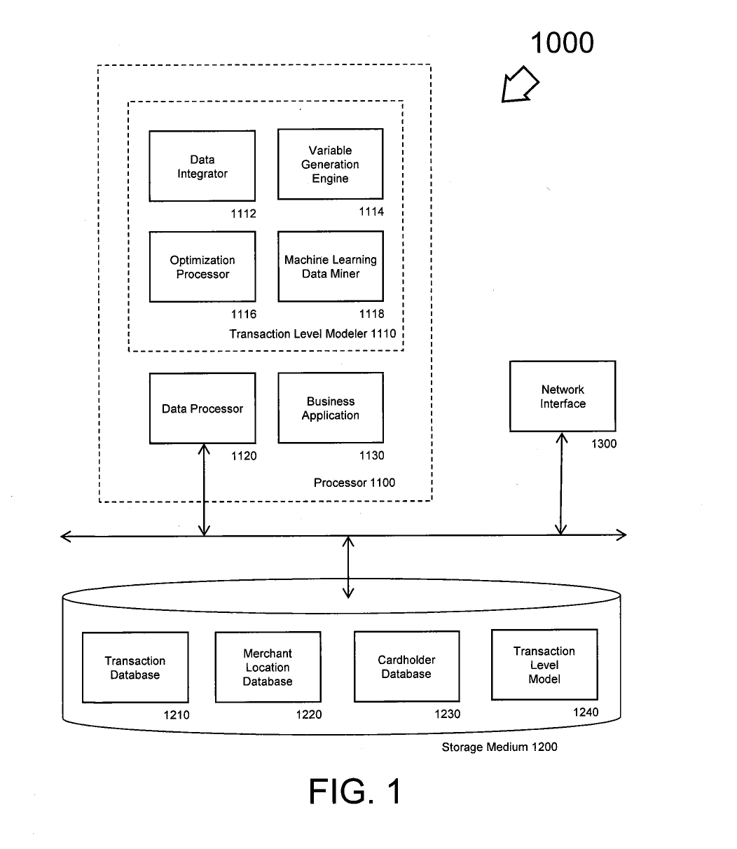

Embodiments will now be disclosed with reference to a block diagram of an exemplary payment network server 1000 of FIG. 1 configured to enable transaction level modeling of payment card use, constructed and operative in accordance with an embodiment of the present disclosure.

Payment network server 1000 may run a multi-tasking operating system (OS) and include at least one processor or central processing unit (CPU) 1100, a non-transitory computer-readable storage medium 1200, and a network interface 1300.

Processor 1100 may be any central processing unit, microprocessor, micro-controller, computational device or circuit known in the art. It is understood that processor 1100 may communicate with and temporarily store information in Random Access Memory (RAM) (not shown).

As shown in FIG. 1, processor 1100 is functionally comprised of a transaction level modeler 1110, a business application 1130, and a data processor 1120.

Transaction level modeler 1110 may further comprise: a data integrator 1112, variable generation engine 1114, optimization processor 1116, and a machine learning data miner 1118.

Data integrator 1112 is an application program interface (API) or any structure that enables the transaction level modeler 1110 to communicate with, or extract data from, a database.

Variable generation engine 1114 is any structure or component capable of generating customer level target-specific variable layers from given transaction level data.

Optimization processor 1116 is any structure configured to receive target variables from a transaction level model defined from a business application and refine the target variables.

Machine learning data miner 1118 is a structure that allows users of the transaction level modeler 1110 to enter, test, and adjust different parameters and control the machine learning speed. In some embodiments, machine learning data miner uses decision tree learning, association rule learning, neural networks, inductive logic programming, support vector machines, clustering, Bayesian networks, reinforcement learning, representation learning, similarity and metric learning, spare dictionary learning, and ensemble methods such as random forest, boosting, bagging, and rule ensembles, or a combination thereof.

Business application 1130 may be any business application that utilizes the transaction level modeler 1110. Example business applications 1130 include a fraud-prevention rule-and-scoring engine, advertisement generator, cardholder convenience and ancillary services applications.

Data processor 1120 enables processor 1100 to interface with storage media 1200, network interface 1300 or any other component not on the processor 1100. The data processor 1120 enables processor 1100 to locate data on, read data from, and write data to these components.

These structures may be implemented as hardware, firmware, or software encoded on a computer readable medium, such as storage media 1200. Further details of these components are described with their relation to method embodiments below.

Network interface 1300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 1300 allows payment network server 1000 to communicate with vendors, cardholders, and/or issuer financial institutions.

Computer-readable storage media 1200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage media 1200 may be remotely located from processor 1100, and be connected to processor 1100 via a network such as a local area network (LAN), a wide area network (WAN), or the Internet.

In addition, as shown in FIG. 1, storage media 1200 may also contain a transaction database 1210, merchant location database 1220, cardholder database 1230 and a transaction level model 1240. Transaction database 1210 is configured to store records of payment card transactions. Merchant location database 1220 is configured to store the geographic location of a merchant. Cardholder database 1230 is configured to store cardholder information and transactions information related to specific cardholders. A transaction level model 1240 may be a model of cardholder transactions, issuer payment data, or merchant purchase data.

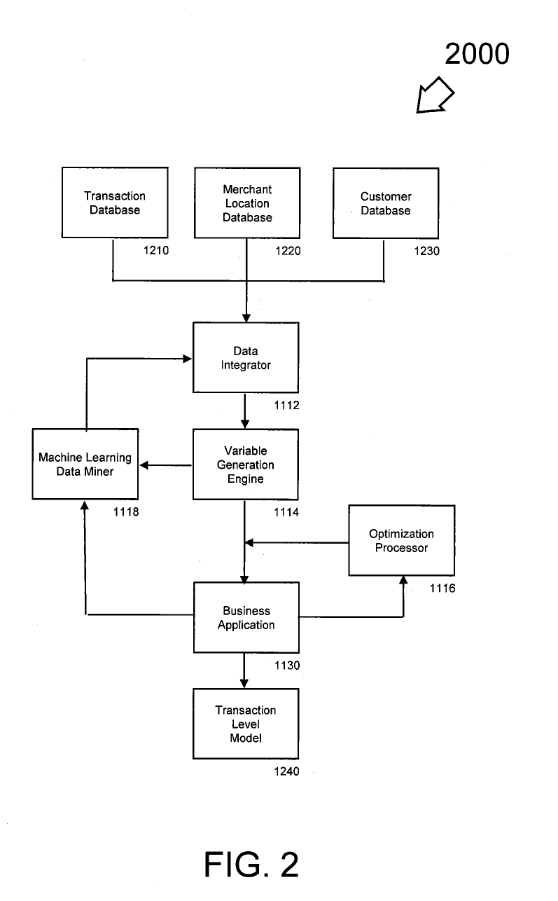

It is understood by those familiar with the art that one or more of these databases 1210-1230 may be combined in a myriad of combinations. The function of these structures may best be understood with respect to the data flow diagram of FIG. 2, as described below.

We now turn our attention to the method or process embodiments of the present disclosure described in the data flow diagram of FIG. 2. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 2 is a data flow diagram of a payment network method 2000 to enable transaction level modeling of payment card use, constructed and operative in accordance with an embodiment of the present disclosure. The resulting transaction level model 1240 may be used in fraud prevention, convenience and elite cardholder services, vendor offers and/or any multiple-layer optimization problem including issuer payment data and merchant purchase data.

Method 2000 may be a real-time or batch method that enables transaction level modeling of payment card use at least in part on cardholder spending.

As shown in FIG. 2, data integrator 1112 receives data from a transaction database 1210, merchant location database 1220, and cardholder database 1230. The data received depends upon the business application 1130.

For example, for an individual cardholder's transaction level fraud model, the cardholder's individual data may be received from cardholder database 1230. For a more general transaction level fraud model, an amalgamated combination of transactions may be received from a transaction database 1210. Embodiments can automatically learn and generate customer level target specific variable layer from given transaction level data.

Data integrator 1112 provides the data to the variable generation engine 1114. For any business application 1130 with at least one transaction attribute of interest, Xᵢ(A;t,l) can denote a transaction attribute variable at transaction level belonging to an account A, by transaction time stamp t, and transaction location 1. For example, X can be payment amount or any transaction related attribute, and V_{A}(x) can be a summarized variable at the customer level which can be any function of original transaction attribute x for a given transaction level model 1240, designated as target T.

Once generated, the transaction attribute of interest is provided to the business application 1130 and the machine learning data miner 1118. The machine learning data miner 1118 receives inputs from both the variable generation engine 1114 and the business application 1130 to refine the transaction level model 1240. Machine learning data miner 1118 starts with dozens of attributes of the transaction data, and computes the implicit relationships of these attributes and the relationship of the attributes to the business application 1130. The machine learning data miner 1118 derives from or transforms these attributes to their most useful form, then selects the variables for the variable generation engine 1114.

Business application 1130 also feeds information to optimization processor 1116. The optimization process happens after the variables are created by modeling processes:

$$V ( x ) {\to }^{Model} T .$$

Optimization processor 1116 maximizes the correlation of the generated variables V with the target T by searching optimal mapping [symbol] and roll-up function [symbol] :

$$\{ {X}_{i} ( A ; t , ℒ ) \} {\to }^{Specific and ℒ to Maximize relevant V \to T} {V}_{A} ( x , T )$$

The searching space for the optimal mapping and functions is large, and the optimization processor 1116 may test the searching process with a limited domain. For example, one simplified approach is to fix the function dimension [symbol] =F, and searching the optimal mapping [symbol] .

In essence, the optimization processor 1116 learns from vast transactional data, explores target relevant data dimensions, and generates optimal customer level variable summarization rules automatically. The optimization processor 1116 is similar to the machine learning data miner 1118, but the difference is that optimization processor 1116 is working on the data that has been aggregated to the account level. The final transaction level model 1240 is implemented on each account for actions to be taken upon.

The optimization processor 1116 starts with selected variables (attributes) of each account (customer) rather than of each transaction. For example, suppose an account has ten transactions. The optimization processor 1116 looks at the “sum” or “average” or any other aggregated attributes selected by the business application 1130 of those ten transactions for the account. The optimization may be accomplished by computing the relationship of these variables to the business application, and derives from or transforms these variables to their most useful form.

The feedback from optimization processor 1116 and machine learning data miner 1118 provides a machine learning approach for transactional data to customer optimization problem. The business applications 1130 are not limited to credit transaction data; it can be applied to any multiple-layer optimization problems such as issuer payment data and merchant purchase data, to automatically generate and implement optimal algorithms to facilitate the analytic and scoring productions.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A payment network method comprising:
receiving transaction data regarding a financial transaction, the transaction data including a transaction attribute;
generating, via a processor, a customer level target specific variable layer from the transaction data;
modeling, via the processor, cardholder behavior with the customer level target specific variable layer to create a model of cardholder behavior;
saving the model of cardholder behavior to a non-transitory computer-readable storage medium.

2. The payment network method of claim 1, wherein the transaction attribute includes a transaction account, a transaction time, and a transaction location.

3. The payment network method of claim 2, the generating the customer level target specific variable layer comprises:
summarizing or averaging the transaction attribute at a customer level.

4. The payment network method of claim 3, the modeling further comprising:
performing a roll-up function.

5. The payment network method of claim 4, the modeling further comprising:
searching an optimal mapping to correlate the customer level target specific variable layer with a fraud model.

6. The payment network method of claim 5, wherein the generating the customer level target specific variable layer further receives feedback from the modeling cardholder behavior.

7. The payment network method of claim 2, wherein the model of cardholder behavior is used for fraud detection, marketing products to the cardholder, marketing services to the cardholder, or market prediction.

8. A payment network comprising:
a processor configured to receive transaction data regarding a financial transaction, the transaction data including a transaction attribute, to generate a customer level target specific variable layer from the transaction data, and to model cardholder behavior with the customer level target specific variable; and
a non-transitory computer-readable storage medium to store the model of cardholder behavior.

9. The payment network of claim 8, wherein the transaction attribute includes a transaction account, a transaction time, and a transaction location.

10. The payment network of claim 9, the generating the customer level target specific variable layer comprises:
summarizing or averaging the transaction attribute at a customer level.

11. The payment network of claim 10, the modeling further comprising:
performing a roll-up function.

12. The payment network of claim 11, the modeling further comprising:
searching an optimal mapping to correlate the customer level target specific variable layer with a fraud model.

13. The payment network of claim 12, wherein the generating the customer level target specific variable layer further receives feedback from the modeling cardholder behavior.

14. The payment network of claim 9, wherein the model of cardholder behavior is used for fraud detection, marketing products to the cardholder, marketing services to the cardholder, or market prediction.

15. A non-transitory computer readable medium encoded with data and instructions, when executed by a computing device the instructions causing the computing device to:
receive transaction data regarding a financial transaction, the transaction data including a transaction attribute;
generate, via a processor, a customer level target specific variable layer from the transaction data;
model, via the processor, cardholder behavior with the customer level target specific variable layer;
store the model of cardholder behavior on a non-transitory computer-readable storage medium.

16. The non-transitory computer readable medium of claim 15, wherein the transaction attribute includes a transaction account, a transaction time, and a transaction location.

17. The non-transitory computer readable medium of claim 16, the generating the customer level target specific variable layer comprises:
summarizing or averaging the transaction attribute at a customer level.

18. The non-transitory computer readable medium of claim 17, the modeling further comprising:
performing a roll-up function.

19. The non-transitory computer readable medium of claim 18, the modeling further comprising:
searching an optimal mapping to correlate the customer level target specific variable layer with a fraud model.

20. The non-transitory computer readable medium of claim 5, wherein the generating the customer level target specific variable layer further receives feedback from the modeling cardholder behavior.
